(19) United States
(12) Patent Application Publication
(10) Pub. No.: US 2008/0252484 A1
(43) Pub. Date: Oct. 16, 2008

(54) Network Message and Alert Selection Apparatus and Method

(76) Inventor: Mark Hopkins, Sussex (GB)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 12/066,750

(22) PCT Filed: Sep. 13, 2006
(86) PCT No.: PCT/GB2006/003424

§ 371 Date: Mar. 13, 2008

(30) Foreign Application Priority Data
Sep. 13, 2005 (GB) 0518617.6

(51) Int. Cl. G08G 1/0967; G01C 21/26

(52) U.S. Cl. 340/905; 701/207; 701/201; 701/117

(57) ABSTRACT

A method of selecting one or more of a plurality of messages for a user, each message associated with one or more particular locations. The method comprises: monitoring journeys of the user; determining a likelihood of the user travelling to the respective particular locations based on the monitored journeys; and selecting a message for the user based on the determined likelihood that the user will travel to a particular location with which the message is associated.

The present invention relates to a message or alert selection apparatus and method, where the alerts are available globally, but apply to specific sections of a network. A network typically consists of links between nodes, and in a road network the links may be roads, and nodes may be junctions.

Conventional alert technology is limited to global or local alerts. For example, whilst travelling on a motorway, a user may receive messages about traffic problems. However, there may be too many across the whole network to provide all of them to a user. There is a requirement to present relevant messages only.

This can be done by disclosing just the most important messages. This is typical of a radio station that reads out traffic announcements. However, local problems of lesser significance are not disclosed and can have a disproportionate effect on an individual user.

An alternative is a device that, knowing the location of the user, provides local information. However, much local information is irrelevant, as say someone travelling on a motorway does not need to know about problems in the towns that they pass, even if the towns are “local” at that time.

Other systems are built into navigation systems, so that alerts related to the route can be shown. In this case the system is told the destination in advance and can identify alerts on route. However, this requires the user to enter the destination of the journey, which is inconvenient and may be difficult for those not accustomed to navigation system technology. Also, the navigation system may choose a route different to that driven by the user.

According to a first aspect of the present invention, there is provided a method of selecting one or more of a plurality of messages for a user, each message, associated with one or more particular locations. The method includes monitoring journeys of the user; determining a likelihood of the user travelling to the respective particular locations based on the monitored journeys; and selecting a message for the user based on the determined likelihood that the user will travel to a particular location with which the message is associated

The position of the user relative to a network of locations can be monitored The network can be predetermined or built up through use of the device.

The locations may be nodes, such as traffic message channel nodes and may be flagged true or false to indicate a direction of travel on the network.

The locations may be connecting links, which are preferably unidirectional.

For each location a turning probability, which may be is biased towards recent events, that the user will travel from that location to each adjacent location can be determined and stored.

To determine the likelihood of a user reaching a particular location, a start location can be set; adjacent locations can be determined; the probability of the user travelling to the adjacent locations can be established based on the stored turning probabilities; the next adjacent locations can be determined; and these steps can be repeated until the probability of the user travelling to each location has been established.

Several locations can be set as the start location at the same time.

According to another aspect of the present invention, there is provided a message apparatus, comprising: receiving means adapted to receive position information, for example GPS signals, and a plurality of messages, such as TMC messages; processing means adapted to carry out a method as described above based on the received position information and the plurality of messages; and alerting means adapted to provide alerts for messages selected by the method.

According to another aspect of the present invention, there is provided a messaging system, comprising: means for receiving position information of at least one vehicle: means adapted to carry out the above described method in respect of the at least one vehicle; and means for transmitting at least one selected message to the vehicle.

Various aspects of the present invention will now be described by way of example only with reference to the accompanying drawings, in which:

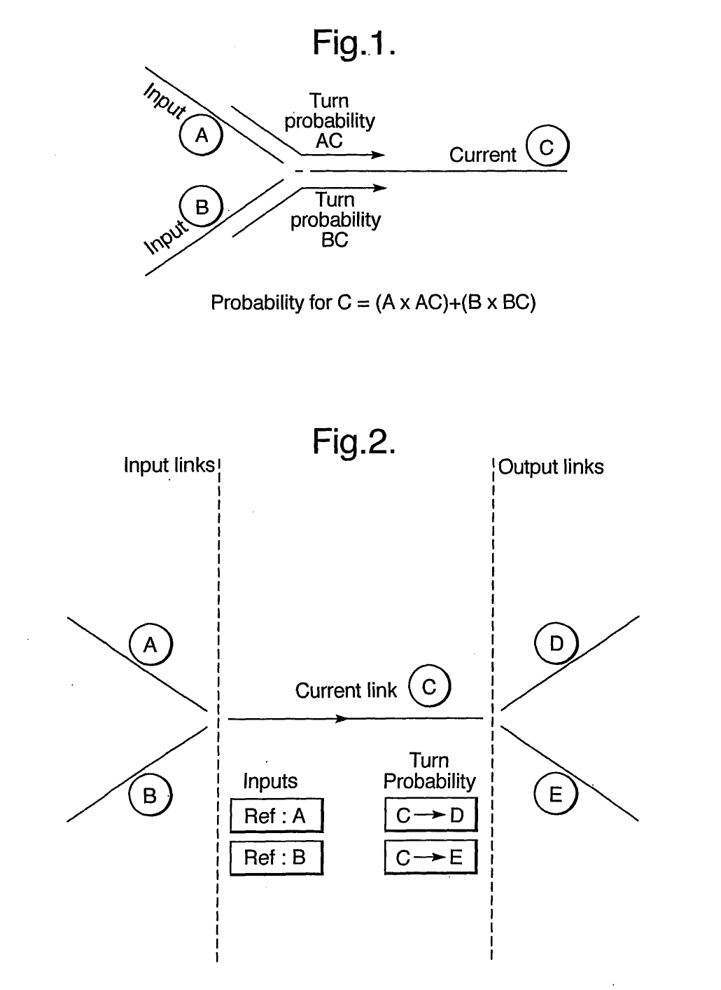

FIG. 1 illustrates how the probability of a driver turning from a particular location on a network to an adjacent location can be determined;

FIG. 2 illustrates how the probability of a driver turning onto a particular location on a network can be determined;

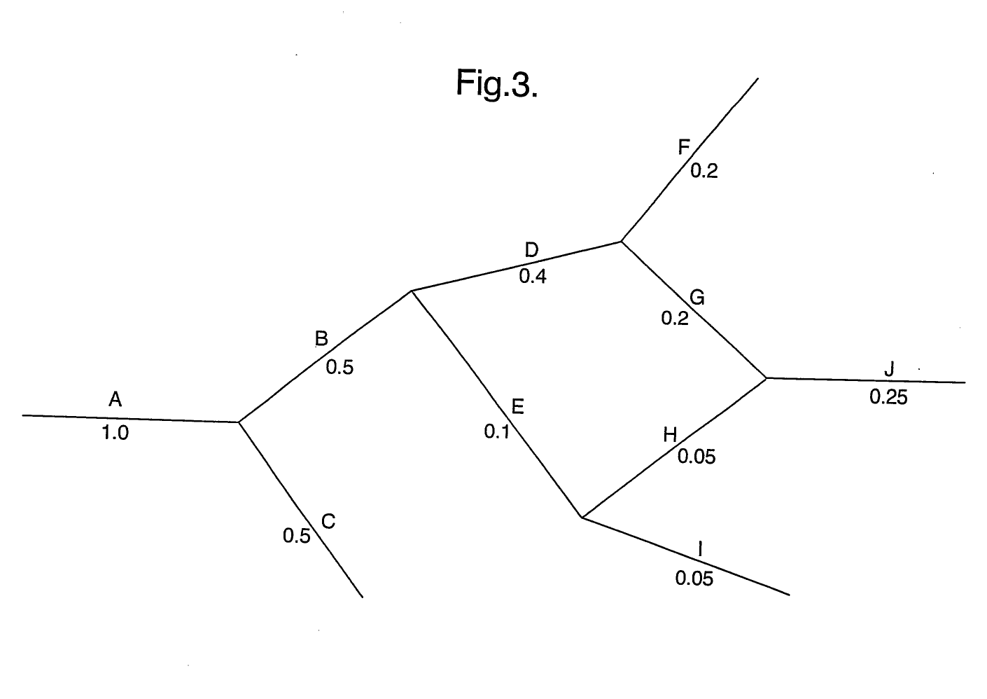

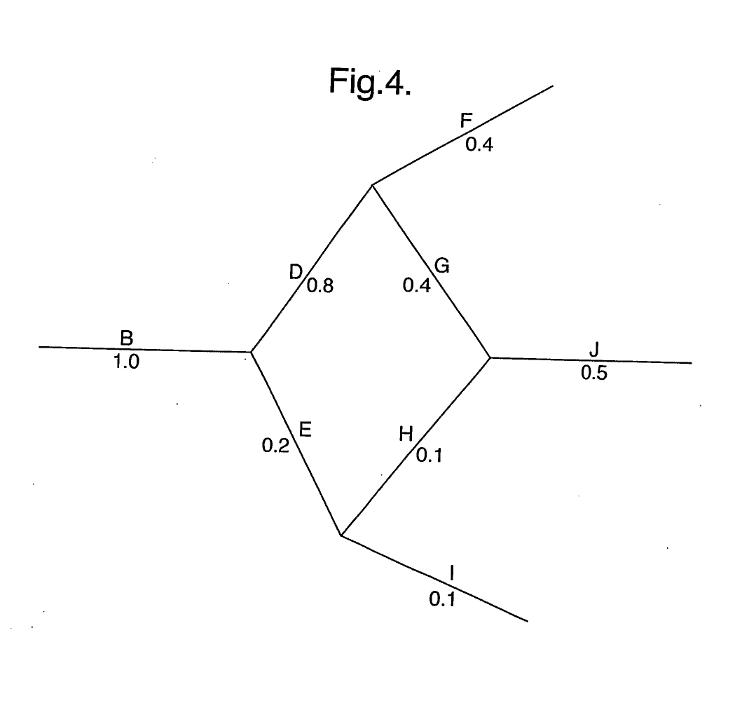

FIGS. 3 and 4 are intended to illustrate how the probability of a driver reaching each of a plurality of locations on a network can be determined;

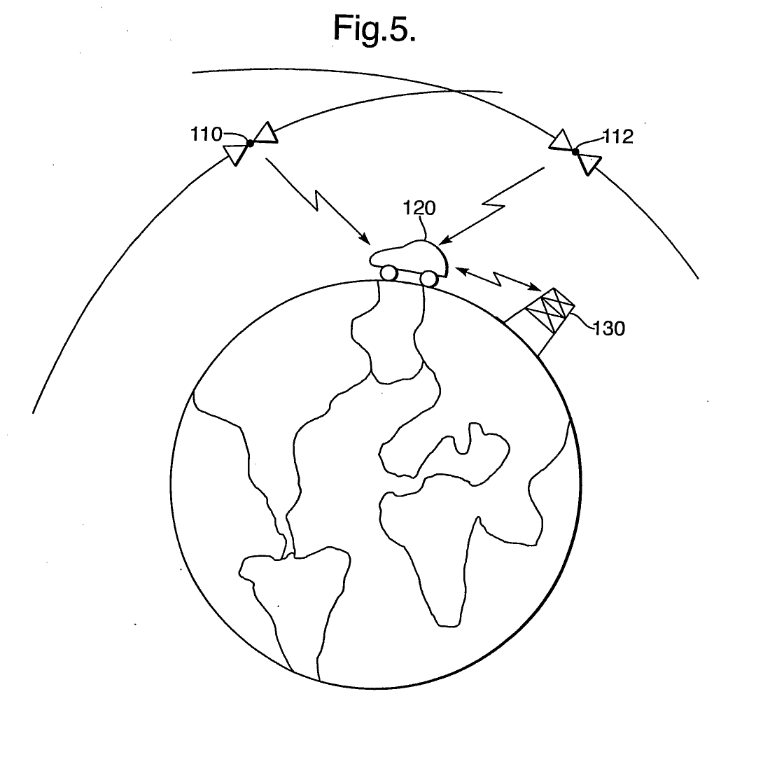

FIG. 5 is an illustration of a system according to one embodiment of the present invention;

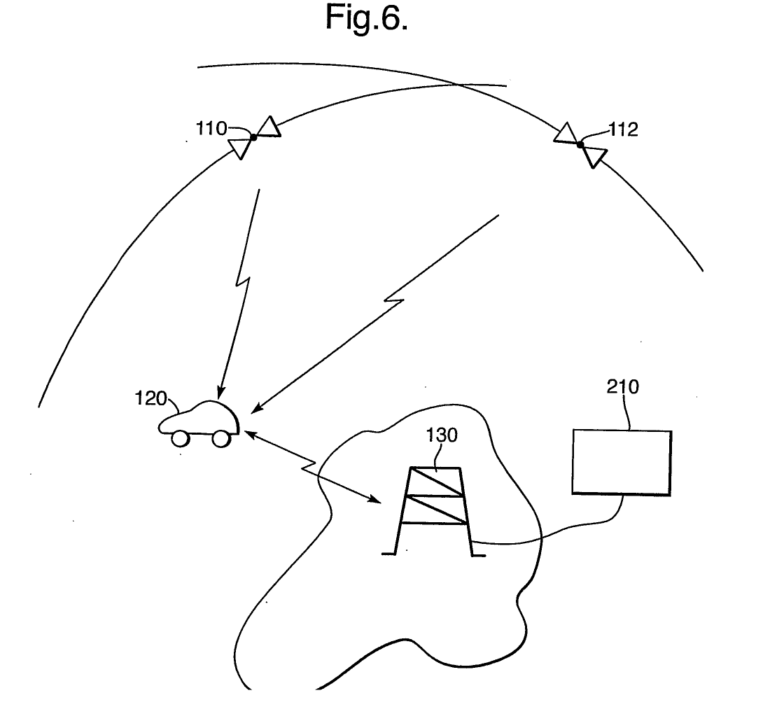

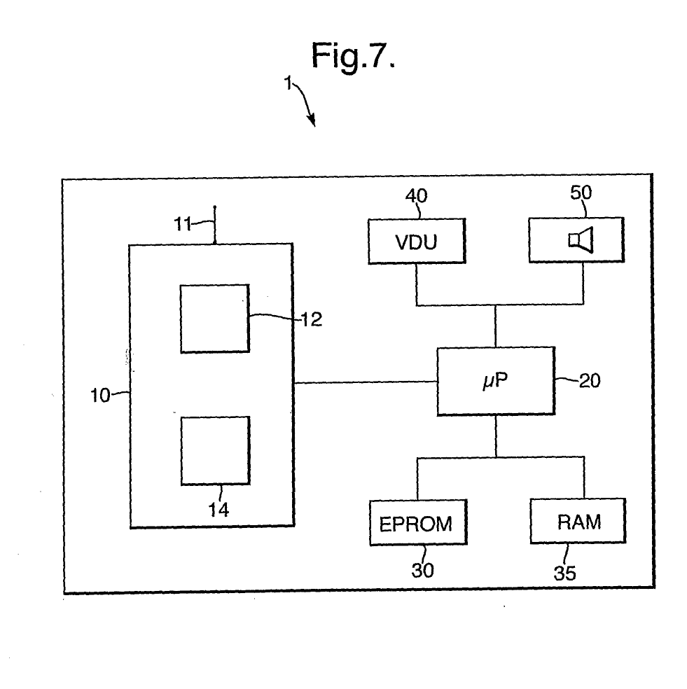

FIG. 6 is an illustration of a system according to another embodiment of the present invention; and

FIG. 7 is an illustration of an on-vehicle traffic messaging system of the present invention.

There now follows a description of exemplary methods and apparatuses according to the present invention for providing a user with traffic alerts given for a road network. A driver of a vehicle wants to know about messages that are important to his journey. The present invention decides this based on the journeys that have been done previously on a network.

In one aspect, the present invention provides a “self-learning” method in which it is possible to work out which journeys are appropriate to the user, and thus choose which alerts are likely to be relevant—even if it is unknown what the final destination or route of the current journey is. The method can be used with various systems such as stand-alone systems, navigation systems, or systems directly built into a vehicle.

A road network may be represented basically, with just key nodes and assumed straight links between, or it may be represented with detailed road locations speeds and distances, but it does not have any information relating to how any particular user travels on the network. In the present invention, this information is built-up as the user travels on the network, and dynamically changed as new journeys are undertaken.

For this example, a device that provides the alerts is assumed to be in-vehicle, learning travel in real-time. However, it need not be in-vehicle and could also learn in a batch mode from pre-stored locations. It can also be pre-set with values directly on the network that make it bias the results from the beginning.

As a journey is made, the position of the user is located on the network, for example by the use of a GPS (Global Positioning System) receiver. This position is used to work out which locations on the network are travelled to more frequently and have been travelled to more recently.

Whilst it would be possible to store many journeys and calculate frequency and “recency” across all of them, in practice a simpler system can be used. This is achieved by storing, for the end of each location, the total number of turns made from each location and counts for each turn.

FIG. 3 shows an exemplary network comprising a series of interconnected links A-J. Each link represents a single location on the network, and each interconnection is a node on the network. To incorporate directionality on the network, each link can be marked true or false, or one link can be provided for each direction. As an example, link A1 would be provided for travelling from left to right in the drawing and link A2 would be provided for travelling from right to left. However, in the example shown in FIG. 3, for ease of illustration it is assumed that the direction of travel is from left to right only, and the links are not flagged and duplicate links are not provided.

Suppose that instead of what is shown in the example in FIG. 3, link A can go to links B, C, or D. Then there are three turns A-B, A-C, and A-D. Each time a turn is taken on a journey this increases the count of that particular turn, and also increases the total count which is spread across all 3 turns.

If the turn made is A-B, then that count is increased and so is the total by 1. The probability percentile is calculated as the count for the turn divided by the total count.

| Turn | Count | Probability |
|---|---|---|
| A-B | 1 | 100.0% |
| A-C | 0 | 0.0% |
| A-D | 0 | 0.0% |

The total is local to the particular set of turns from A. In a bi-directional road, the two links in either direction are separate. So “A-D” in this example, could be a U-turn if D was the opposite link to A. Using the annotation discussed above for bi-directionality of links, “A-D” in this example would be “A1-A2”.

Optionally, when the next turn is made from the link, prior to adding 1 to the count and total, a reduction factor is applied. Suppose this is 10%, this reduces the value of prior turns and ensures that the overall probabilities are biased towards recent events.

Applying a 10% reduction reduces the total to 0.9 and gives:

| Turn | Count | Probability |
|---|---|---|
| A-B | 0.9 | 100.0% |
| A-C | 0 | 0.0% |
| A-D | 0 | 0.0% |

Suppose the new turn is A-C, which increases the total to 1.9 and a table of:

| Turn | Count | Probability |
|---|---|---|
| A-B | 0.9 | 47.4% |
| A-C | 1 | 52.6% |
| A-D | 0 | 0.0% |

Another A-C turn with a reduction and addition gives a total of 2.71, and the table:

| Turn | Count | Probability |
|---|---|---|
| A-B | 0.81 | 29.9% |
| A-C | 1.9 | 70.1% |
| A-D | 0 | 0.0% |

The total of each outward turn is 100%, and the turn-probability represents the frequency and recency of making that turn. In other words, it is a single figure that combines the likelihood of a making any particular turn, compared to other turns at that location, preferably towards recent journeys.

The above method creates network information that can be used to select appropriate messages as explained below.

The network, together with the turn-probability information, is used to calculate and select appropriate messages. This is done in a 3 stage process that converts the local turn information into a choice of which of the global messages are most relevant.

### Stage 1

A modified “find minimum path” method is used to calculate the likelihood of reaching any link on the network from a given start location. This varies by requiring a maximum (rather than minimum) probability value, and this value is the sum of all the previous turn/link combinations rather than a single best (previous) link.

FIGS. 1 and 2 are illustrative of how the probability of travelling to different links in a network can be determined. FIG. 1 shows a small section of another exemplary network, in which only links A and B feed into link C and in which it is possible to turn from link C into links D and E only.

The probability of turning into link C can be calculated as shown in FIG. 2. More specifically, the probability of turning into C can be calculated as the previously determined probability of travelling to link A multiplied by the previously stored turn probability of turning from link A into link C (as opposed to link B, for example) added to the previously determined probability of travelling to link B multiplied by the previously stored turn probability of turning from link B into link C (as opposed to link A, for example).

As shown in FIG. 1, the now determined probability of travelling to link C can be used in the determination of the probability of travelling to links D and E.

Of course, each link can have more than two input links and more than two output links.

The processing can be carried out using the following steps:
a. All links have an initial probability value zero, except the start link which has 1.0 (100%).
b. The start link may actually have the 1.0 value divided over multiple start links. The start links are added to the links in a Process List (the “PL”). The start links are only ever added to the PL once. They are not repeated even if reached by other means during this method.
c. The first/top link is taken from the PL. This will initially be (one of) the start link(s). Start links have fixed probabilities, but all other links calculate their probability value from the sum of all input links. (Input links are previous links with turns into the current link).
d. To calculate the current link probability—that is, the probability of travelling to the current link in the process list—a list of all input links to the current link is used. Each input is checked for its contribution to the current link. The input link checks the current link against a list of all the links that its output turns lead to. It can match the current link to find the network probability value for that turn. Finally the contribution is calculated by multiplying the probability on the input link by the probability of making the turn to the current link, using a method such as that shown in FIG. 2 and described above.
e. When the current link has all the input contributions, it sums these to calculate its current calculated probability, again using a method such as that shown in FIG. 2 and as discussed above. This current probability is then stored, and all the output links from the current link (except any “start” links) are added to the PL. The current link is removed from the PL and the method continues with the next link at step (c). Optionally, this current calculated probability may be compared with a threshold before being stored. If it falls below the threshold, it is considered not to be relevant to the user and is discarded without being stored. In that case, the output links from the current link can also be discarded—that is, not added to the process list.
f. The process rebeats until all links have been removed from the PL and thus each link has reached its maximum probability from the given starting point.

Applying this to the exemplary network shown in FIG. 3, the start link is link A. The probability of being positioned at that link is 1.0 (100%) and this is stored. In this example, the stored turn probabilities of making the various turns are:
A-B: 50%
A-C: 50%
B-D: 80%
B-E: 20%
D-F: 50%
D-G: 50%
E-H: 50%
E-I: 50%
G-J: 100%
H-J: 100%
G-H: 0%
H-G: 0%

The output links from start link A are links B and C. These are added to the process list and the probability of travelling to each is calculated in turn as it comes up as the current link on the process list.

After the start link, the first link on the process list is link B and this is set as the current link. The probability of B is 0.5 (1.0×50%), which is added to the store, and its output turns D and E are added to the process list. Link B is removed from the process list.

Processing moves on and link C is set as the current link. The probability of C is also 0.5, which is added to the store. There are no output turns for C and the process list is unchanged, apart from the removal of link C from the process list.

Links D and E are subsequently set, in turn, as the current link. Each has only one input. The probability of turning from B to D is 80% and from B to E is 20%. Thus, the respective contributions for Dand E are 0.4 (05×80%) and 0.1 (0.5×20%). D has output turns F and G, and E has output turns H and I, and these output turns are all added to the process list.

There is an equal chance of travelling from D into F and G, so in each case the total probability is 0.2. Similarly, there is an equal chance of travelling from E into H and I, so in each case the total probability is 0.05.

Finally, both G and H have only ever been recorded as travelling to J (since turn probability G-H=0% and turn probability H-G=0%) and the probability of travelling to J is therefore given as 0.25 (0.2+0.05).

From the foregoing, it can be seen that the probability of the user travelling to each location on the network from link A can be established. Preferably, this probability is weighted towards recent journeys, for example in the manner discussed above.

The user can then be alerted to traffic messages considered to be relevant to him on the basis of the determined probabilities. For example, traffic messages associated only with links having a probability higher than a certain value can be considered relevant. As mentioned above, once the probability of a user reaching a link has been determined, this can be compared with a threshold in step f, if the current link has a higher probability than the threshold, it is stored and its output links are added to the process list. Otherwise, it is not stored and its output links are not added to the process list.

Alternatively, if the current link has a lower probability than the threshold, it is not stored but its output links are added to the process list.

In another alternative, the probability of the user reaching the current link is stored for all current links and all processing to determine relevance is performed later.

Threshold processing applied to the processing as discussed above in relation to steps a-f above can reduce the amount of processing performed, thereby allowing faster calculation and/or reducing the expense of components required to produce an effective apparatus. If a threshold of 0.25 were to be applied to processing in the example shown in FIG. 3 so that if the current link has a lower probability it is not stored and its output links are not added to the process list, it can be seen that link E (having a probability of 0.1) would be discarded. Thus, links H and I would not be added to the process list and would be discarded from further probability calculation processing. Similarly, links F and G would be discarded. Consequently, J would be discarded too. In the example, then, traffic alerts would not be given for links other than A-D. Of course, the processing threshold can be set at any desired level.

This type of threshold processing is also useful to prevent excessive iteration on circular routes. For example, assume that a possible route is A-B-C-A-B- and so on. As the circular route is processed, the probability of travelling to each link becomes progressively lower and eventually the probability falls below the predetermined threshold. Consequently, the output links of the link having the probability below the predetermined threshold are not added to the process list and processing of the circular link is cut out.

In a preferred embodiment, the probability of reaching the current link is compared with a previously stored value for reaching that link. If (and only if) the probability of reaching the current link is higher than the previously stored value for that link, the probability of reaching the current link is newly stored as the probability of reaching that link.

In a still further preferred embodiment, if (and only if) the probability of reaching the current link, is higher than the previously stored value for that link by a margin of X or more, the probability of reaching the current link is newly stored as the probability of reaching that link. This both has the effect of cutting out unnecessary processing of circular routes and improves relevancy processing

Depending on the chosen implementation of these preferred embodiments, the output links for the current link may or may not be added to the process list if the probability of reaching the current link is not higher than the previously stored value for that link by a margin of X or more.

As the user's journey progresses, the probabilities of him reaching the different locations on the network are re-calculated dynamically on an ongoing basis. Assume, for example, that the user travels from start link A to link B in FIG. 3. The count of the number of turns from link A is increased by 1, and the stored turning probability of the user turning from A into B is changed accordingly, for example using the method described above. Link B is then reset as the start link and the processing begins again.

As mentioned above, links are preferably uni-directional, so links A and C are now discounted. The resulting portion of the network used for calculation is shown in FIG. 4.

Since B is set as the start link, the probability of the user travelling to B is set at 1.0 (100%) and the probabilities for the remaining links are recalculated based on the new contribution from B and the predetermined turning probabilities.

It can be seen that if the threshold processing method were to be used for the example in FIG. 4, links E, H and I would all be discounted. However, the probabilities of travelling to links F, G and J would now all be stored. Consequently, it can be seen that the traffic messages to which the user is alerted can be adapted as the user's journey progresses.

As mentioned above, links are typically implemented as uni-directional, so two links are provided if a journey is made in both directions. This is the reason A is discounted in FIG. 4. However, it would be possible to include the reverse direction in the network shown in FIG. 3, for example by storing a U-turn at the A-B/C interface. Effectively, the output turns from A1 would be A1-B, A1-C and A1-A2, where A2 is the reverse direction of A1. Of course, if the user has never made a U-turn at the A-B interface, the stored turning probability will be zero and the link A2 will be discounted.

In a similar way, a journey in the reverse direction may have a link from B to C. However, this would be stored as separate links, so there would be a B1 and B2. Thus, in FIGS. 3 and 4 an outward journey could be A-B1-D1 etc, with a journey in the return direction being D2-B2-C. Of course, if C were two-directional then there would be C1 and C2 too.

The determination as to the relevance of traffic messages can optionally be refined using stages 2 and 3 discussed below. However, in practice it has been found that excellent results can be achieved without these stages, the relevance of traffic messages being ranked based on the stored, calculated probabilities of the user reaching each link. The user is alerted to only the most relevant messages (for example those messages associated with a link having a stored, calculated probability higher than a predetermined threshold, or a set number of most relevant messages).

### Stage 2

Each link may be associated with a “cost”, which is typically the expected time taken to traverse the link. Alternatively or in addition, the cost can take into account whether the link is a trunk road (A road) or a minor road (B road). The cost may be based on stored network information generated from monitoring the user's journeys but is more typically a predetermined cost provided for each link. Each link cost can be divided by its respective link probability which has been calculated in stage 1.

Thus, links with a high probability (up to 1.0) are reatively unchanged. Links with low probability (or even 0) are set to the maximum cost, and for all practical purposes are unreachable. Other links fill the range between.

Thus, the relevance of the link to the user can be adjusted based on the “cost” and the selection of traffic messages can be adjusted accordingly.

A conventional minimum-path method can be used to determine a route “tree” from the start location(s). Various minimum path algorithms are well-known in the art. Generally, they work out a “route” across a network that is the least cost. For example, they may work out the fastest way from Brighton to London where cost=time, so least cost=fastest time. Such minimum path methods are useful in many areas, not just journey calculations. They vary, but typically calculate the cost it would take to get from A to B, by trying (often exhaustive) other paths until minimum cost is reached. They may build a tree out from the start, where each link knows the “cost to reach itself so far” plus “which link was the one before down the tree”. By repeated testing, the lowest cost to reach the end can be found. In this way, the final, lowest cost can be determined and, by working backwards the path that created it can be generated.

### Stage 3

Following stages 1 and 2, the global link values can now combine the likelihood, recency, and speed of links to determine relevance.

The relevance of those links with alerts pertaining to them can now also be multiplied by the alert “importance”. In this way, a more significant alert can take precedence even if further away.

As mentioned above, stages 2 and 3 are optional in the sense that the probability from stage 1 can give good results by itself, then the other stages refine this.

The alert are ordered with the highest values of likelihood/recency/speed/importance first, which gives they key messages to provide to the user. The end result of this is that a user, even from the start of their journey, can be alerted to incidents that are highly relevant to their typical journey(s) from their current location.

Throughout the journey the present invention will both build up network turn probabilities and at the same time repeatedly check (using a one-, two- or three-stage process) for relevant messages.

A feature of this invention is that if there are routes which are only used occasionally, then they will remain in the “memory” in the form of the local turn information. From a given start point, the messages will be for the common routes as the probabilities are biased that way. However, the moment the vehicle passes a key turning away from these, the occasional route becomes highly likely. Importantly all the later turns retain their local turn probability values, and are unaffected by the use of the system in other areas.

As a fallback position, if there are no known routes because the system has no data acquired in a given area, then local and/or important alerts are given as a temporary measure.

The final messages are output in the form of audible, visual of other means, for example electronically to another device.

In the foregoing description, locations on a network are represented by links, the links interconnecting at nodes to form the network. However, this form of network need not be used.

A Traffic Message Channel (TMC) is a specific application of the FM Radio Data System (RDS) used for broadcasting real-time traffic and weather information. TMCs have been established in a large number of countries. Data messages are received and decoded by a TMC-equipped car radio, in-car or other, navigation system, or other device such as a PDA. TMC may be delivered using the RDS Radio Data Service over the FM radio network, DAB digital radio, GPRS data transfer, mobile Internet, paging and GSM/GPRS mobile phone networks, or any other suitable mechanism.

TMC traffic information systems conform to a global standard and typically use a common list of location codes for a strategic road network, with different TMC traffic information providers using encryption of their respective TMC streams for protection if required. In some countries, different providers use independent lists of location codes. In either case, data related to traffic flows, incidents, weather etc. are gathered, collated and subsequently passed to a TMC traffic information service provider, who generates and broadcasts TMC messages according to a predetermined coding protocol. The TMC data are received by an antenna, and decoded by a TMC decoder. This reconstructs the original message, using a database of event and location codes, which can then be presented to the driver as a visual or spoken message.

In a preferred embodiment of the present invention, a network or pseudo-network of TMC locations or nodes is used. This may consist of just main road junctions as nodes, with assumed straight lines as links in between. TMC nodes are typically flagged true/false for the direction indicator. Thus, the user travels from TMC node to TMC node in the network and the probabilities of travelling from one node to each adjacent node (which includes otherwise related nodes) are built up as the turning probabilities. Effectively, the turning probabilities are node-to-node probabilities.

In the event that nodes are flagged true/false to indicate direction, “multiple junctions” can be handled by storing additional nodes. For example, imagine a trunk road (A road) intersects a minor road (B road) to form a crossroads. There will be a plurality of nodes along each of the A and B roads. At the crossroads, one node will be provided for the A road and one node will be provided for the B road. Thus, there are two nodes at the cross-roads rather than a single node.

In the foregoing description, it is assumed that the present invention uses a pre-stored network including, for example, the whole road network of a particular country. However, in a preferred embodiment, the network is built up from scratch as journeys progress. Thus, each time the user passes a new TMC node or junction or reaches another predetermined location, a new node or link is added to the network and the associated node-to-node (turn) probabilities are updated. Identifying a TMC node might be performed directly by using a GPS co-ordinate or indirectly e.g. because a navigation system uses the GPS location to identify the road, which itself is matched to the TMC information.

Once the network is started or built, it can be extended further and new intelligence on turns is added as the user re-visits the same places. Similarly, if it is not predetermined, cost information can be updated as journeys progress.

Setting of the start position for calculating the probabilities of the user travelling to a particular location may be implemented in 3 stages:
(1) Choose local nearby links/TMCs in a radius around the start point, and merge results.
(2) When the first link/TMC is reached, choose just that link, but assume the user can go in either direction—that is, use links A1 and A2 for example.
(3) Once the second link/TMC has been passed, both the link and the direction can be determined. Alternatively, it would be possible to pick up the direction of travel sooner, for example by comparing a compass heading and the underlying link.

FIG. 7 is illustrative of a traffic alert apparatus 1 according to the present invention and FIG. 5 is illustrative of a system 100 of the present invention.

The traffic alert apparatus 1 in FIG. 7 comprises a receiver section 10 having an antenna 11 for receiving signals. The receiver section 10 also comprises a global positioning system (GPS) signal receiver 12 and a radio signal receiver 14 for receiving GPS and traffic alert signals respectively. A separate antenna may be provided for each receiver, if required. The traffic alert apparatus 1 further comprises a microprocessor 20, connected to an electrically programmable read only memory (EPROM) 30 and a random access memory (RAM) 35. Programming information for the processor 20 is stored on the EPROM 30, together with location information for the network, including cost information for each link or node, if used, and turn count and possibly turn probability data for each link or node. If TMC is being used, TMC location and event codes may also be stored in the EPROM 30. Thus, the EPROM 30 is updated with new turn count information and new links/nodes as necessary. The RAM 35 is used to store processing information calculated by the microprocessor 20, including the calculated turn probabilities (if not stored in the EPROM 30), the process list and the probabilities of the user reaching a particular location as the process list is worked through.

The GPS and traffic alert signals are transmitted to the microprocessor 20, which decodes them and uses them to carry out the above-described method to determine the position of the user, update network information and calculate the probability of the user reaching a particular location and hence the relevance of any received traffic alerts. Once a traffic alert is determined to be relevant, the user is alerted by means of the VDU 40 and/or speaker 50.

The system 100 shown in FIG. 5 comprises satellites 110, 112 orbiting the earth and transmitting GPS signals. A traffic alert apparatus 1 such as that shown in FIG. 7 is installed in vehicle 120 and receives the GPS signals from the satellites 110, 112. Typically, GPS signals from four satellites are received to accurately determine the position of the vehicle. The traffic alert apparatus 1 also receives the traffic alert information from a network of transmitters 130. It uses this information to update the network information it holds and determine whether any receive traffic alerts are relevant to the user.

In FIG. 6 shows a system 200 similar to that shown in FIG. 5. However, the traffic alert apparatus 1 is not provided in the vehicle 120. Instead, the vehicle 120 transmits its position to one or more transmitters/receivers 130 of a network. The receiver(s) 130 transmit this information together with a vehicle identification to a base station 210, which stores network data for the identified vehicle. The base station 210 then selects relevant traffic alerts on basis of how likely the vehicle is to travel to any given location and sends them to the vehicle through the transmitter(s) 130. The base station 210 can provide this function for a plurality of vehicles.

The present invention has been described with particular reference to providing a user with traffic messages and on-vehicle traffic message alerting and navigation systems. However, it should be appreciated that the present invention has broader applications and requires the provision of neither traffic messages nor on-vehicle apparatuses.

For example, messages provided to the user can convey any type of information, including for example weather information, changes in road layout, and information of local interest. The present invention is also applicable to hand-held apparatuses, such as hand-held navigation devices and PDAs. Moreover, the network may be a road network, a cycle path network, a footpath network, or even a flight path network.

The foregoing description has been given by the way of example only and it will be appreciated by a person skilled in the art that modifications can be made without departing from the scope of the present invention. For example, the architecture described for the traffic alert apparatus is non-limiting and, in particular, different arrangements of receivers, memories, decoders and other processors, and alerting means (VDUs and speakers) are all possible. The traffic alert apparatus 1 need not be installed in-car, but can be implemented, for example, in a PDA. Similarly, the use of GPS is not required for determining the position of a vehicle. Rather, radio signals from strategically positioned beacons can be used.

1. A method of selecting one or more of a plurality of messages for a user, each method comprising: monitoring journeys of the user;
determining a likelihood of the user travelling to the respective particular locations based on the monitoring journeys; and
selecting a message for the user based on the determined likelihood that the user will travel to a particular location with which the message is associated.

2. A method according to claim 1, wherein the step of monitoring comprises monitoring the position of the user relative to a network of locations.

3. A method according to claim 2, wherein the network is a predetermined network.

4. A method according to claim 2, wherein the monitoring step comprises building a network of locations.

5. A method according to claim 2, wherein the locations are nodes.

6. A method according to claim 5, wherein the nodes are traffic message channel nodes.

7. A method according to claim 5, wherein the nodes are flagged true or false to indicate a direction of travel on the network.

8. A method according to claim 2, wherein the network is formed of connecting links, each link being a location on the network.

9. A method according to claim 8, wherein each link is unidirectional.

10. A method according to claim 2, wherein the likelihood determining step comprises determining and storing for each location the turning probability the user will travel from that location to each adjacent location.

11. A method according to claim 10, wherein the turning probability is biased towards recent events.

12. A method according to claim 10, comprising:
setting a starting location;
determining adjacent locations;
in any order, establishing the probability of the user travelling to the adjacent locations based on the stored turning probabilities and determining next adjacent locations; and
repeating the determining and establishing steps until the probability of the user travelling to each location has been established.

13. A method according to claim 12, wherein the step of setting the start location may comprise setting a plurality of start locations.

14. A method according to claim 12, wherein, if it is established that the probability of the user travelling to a location is below a predetermined threshold, the probability of travelling to a location is below a predetermined threshold, the probability of travelling to respective next adjacent locations is not calculated or is set as zero.

15. A method according to claim 12, wherein, if it is established that the probability of the user travelling to a location is not greater than a previously stored probability of the user travelling to that location, the probability of traveling to respective next adjacent locations is not calculated or is set as zero.

16. A method according to claim 1, wherein the selecting step comprises adjusting the determined likelihood based on a predetermined cost of the location.

17. A method according to claim 16, wherein the cost is the time taken to traverse the location or the speed of travelling on the location.

18. A method according to claim 1, wherein the selecting step comprises adjusting the determined likelihood based on a predetermined importance of the message.

19. A method according to claim 1, comprising using a minimum path method to determine a route tree.

20. A method according to claim 1, wherein one or more messages local to the position of the user and/or one or more important messages are selected when the user is at a previously unmonitored position.

21. A method according to 1, wherein the step of monitoring comprises receiving a batch of information pertaining to user journeys.

22. A method according to claim 1, wherein the message is a traffic message.

23. A message apparatus, comprising:
receiving means adapted to receive position information and a plurality of messages;
processing means adapted to carry out a method according to any one of the preceding claims based on the received position information and the plurality of messages; and
alerting means adapted to provide alerts for messages selected by the method.

24. A message apparatus according to claim 23, wherein the receiving means is adapted to receive position information from global positioning system satellites.

25. A message apparatus according to claim 23, wherein the receiving means is adapted to receive position information by means of a radio signal.

26. A messaging system, comprising:
means for receiving position information of at least one vehicle;
means adapted to carry out a method according to claim 1 in respect of the at least one vehicle; and
means for transmitting at least one selected message to the vehicle.

27. A message apparatus, comprising:
receiving means adapted to a message selected by a method according to claim 1; and
alerting means adapted to alert a user to the selected message.
